(19) United States
(12) Patent Application Publication
(10) Pub. No.: US 2026/0330553 A1
(43) Pub. Date: Oct. 22, 2026

(54) COMPUTERIZED METHOD FOR ADMINISTERING AN INVESTMENT FUND

(71) Applicant: Takolusa Capital LLC, Holmdel, NJ (US)

(72) Inventor: Pradeep Jhanjee, Holmdel, NJ (US)

(21) Appl. No.: 19/184,635

(22) Filed: Apr. 21, 2025

(51) Int. Cl. G06Q 40/06; G06Q 30/0601

(52) U.S. Cl. CPC G06Q 40/06; G06Q 30/0641

(57) ABSTRACT

Described herein are methods for administering an investment fund having a plurality of shares, a managed distribution schedule comprising a plurality of consecutive temporal periods and a payment (P(t)) to be provided to an investor during each of the consecutive temporal periods, and an investment strategy for investing in assets to provide funds sufficient to meet the managed distribution schedule. The methods described herein may comprise providing non-transitory memory instructions that cause a computer processor to perform certain method steps. These method steps may comprise modeling, with the computer processor, the investment strategy by defining a future real cash flow (FRCF) equal to P(t), wherein P(t) equals a predetermined payout unit (“PPU”) in the future (example $100) as of the time of the investment, multiplied by inflation factor (IF), wherein the computer processor may calculate IF by dividing a projected future inflation index at time (t) by inflation index at time of investment (t=0). The present value of P(t) plus the present value of running operational fees F(t) is the investment unit X(t). The method steps may further comprise the computer processor generating a visual output comprising digital images comprising a series of potential start dates for the payments (P(t)) to begin, a series of potential number of consecutive temporal periods for which the payments (P(t)) will continue to be made, and consecutive payment amounts (P(t)). The method steps may further comprise the computer processor receiving as an input via a user interface selected values for a start date for the payments (P(t)) to begin, a number of consecutive temporal periods for which the payments (P(t)) will continue to be made, and consecutive payment amounts (P(t)). The method steps may further comprise the computer processor calculating, based on the input, the value of each of the payments (P(t)) to be provided according to the managed distribution schedule using the investment strategy. The method steps may further comprise the computer processor calculating a price (I) per FRCF investment unit. The method steps may further comprise the computer processor receiving as an input via a user interface an instruction from the investor whether or not to execute a purchase at price (I).

### FIELD OF THE INVENTION

The present invention relates to a computerized method for administering an investment fund that includes providing non-transitory memory instructions that cause a computer processor to execute investment strategies that substantially guarantee a retiree a pre-determined minimum regular income receivable on a periodic basis for a pre-determined period of time.

### BACKGROUND

Investors planning for retirement, particularly as they age, often prefer to avoid high levels of investment risk even if it means a lower ceiling on their potential investment returns. Therefore, many investors may trade large potential returns on their retirement investments in exchange for guaranteed or substantially guaranteed lower returns. One aspect of the present invention, therefore, is to describe and enable a computerized investment strategy that provides an investor with a veritable floor below which the investor's investment returns are highly unlikely to decrease.

People planning for retirement often have retirement lifestyle aspirations based upon how they currently live. They may know what the monthly cost of this lifestyle is in today's dollars but may not know the cost of that lifestyle during their future retirement due to inflation or deflation. Therefore, one problem that arises when people plan for retirement is how to translate their present day financial expenditures into a suitable budget for retirement expressed in present day, real dollars so as to facilitate estimating future living expenses.

What is needed is a computerized investment method that provides an investor with a minimum guaranteed or substantially guaranteed future income stream that has today's purchasing power. What is needed is an investible fund and associated computerized investment strategy that enables a guaranteed or substantially guaranteed future cash flow stream that may be expressed in real dollars (i.e., in present day dollars) thereby allowing an investor to determine with accuracy the number and type of shares of the fund to purchase. What is needed are liquid investment units of the nature identified above that are priced sufficiently low that they can be readily purchased in varying quantities over time without imposing unnecessary financial strain on the investor.

### SUMMARY

Described herein are methods for administering an investment fund having a plurality of shares, a managed distribution schedule comprising a plurality of consecutive temporal periods and a payment (P(t)) to be provided to an investor during each of the consecutive temporal periods, and an investment strategy for investing in assets to provide funds sufficient to meet the managed distribution schedule. The methods described herein may comprise providing non-transitory memory instructions that cause a computer processor to perform certain method steps. The method steps may comprise modeling, with the computer processor, the investment strategy by defining future real cash flows (FRCF) each equal to P(t), wherein P(t) equals a predetermined payout unit (“PPU”) in the future (e.g., $100) multiplied by inflation factor (IF). The computer processor may calculate (IF) by dividing a projected future inflation index at time (t) by that inflation index at the time of investment (t=0). The present value of P(t), plus the present value of the running operational fees, is the investment unit X(t). The method steps may further comprise a computer processor generating a visual output comprising digital images comprising a series of potential start dates for the payments P(t) to begin, and a series of potential number of consecutive temporal periods for which the payments P(t) will continue to be made. The method steps may further comprise the computer processor receiving as an input via a user interface selected values for a start date for the payments P(t) to begin, and a number of consecutive temporal periods for which the payments P(t) will continue to be made. The method steps may further comprise the computer processor calculating, based on the input, the value of each of the payments (P(t)) to be provided according to the managed distribution schedule using the investment strategy. The method steps may further comprise the computer processor calculating a price (I) per investment unit FRCF; and receiving as an input via a user interface an instruction from the investor whether to execute a purchase at price (I).

### BRIEF DESCRIPTION OF THE DRAWINGS

FIG. 1 depicts a graphical illustration of a conceptual basis for a future real cash flow (FRCF) investment strategy as described herein.

FIG. 2 depicts a flow chart view of illustrative method steps that may be utilized in connection with computerized methods for administering an investment fund, as described herein.

FIG. 3 depicts a table setting forth pricing information for one share of an example FRCF investment instrument as described herein providing for monthly real dollar payments of $100 beginning at a predetermined future time (t) that may be purchased using the computerized methods described herein.

FIG. 4 depicts graphical and tabular illustrations as an example of how discount factors as discussed herein may be determined.

### DETAILED DESCRIPTION

The following disclosure is provided to describe various embodiments of a computerized method for administering an investment fund. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more elements in that group, which may be included with other elements of the group. All numbers, measurements, and values are given as approximations unless expressly stated otherwise. Approximations should be understood as allowing for variation of at least 5% above and below the subject value.

For the purpose of clearly describing the components and features discussed throughout this disclosure, some frequently used terms will now be defined, without limitation. The term “repurchase house” or “repo house,” as used throughout this disclosure, shall mean a financial institution that borrows or lends money secured by securities. For purposes of this disclosure, a repurchase house or repo house may be either a stand-alone entity, or may be a department within the same firm that administers the investment fund. The term “swap house,” as it used throughout this disclosure, shall mean a financial institution that enters into contracts that exchange or swap one set of cash flows for another. For purposes of this disclosure, a swap house may be either a stand-alone entity, or may be a department within the same firm that administers the investment fund. The term “U.S. treasury debt instruments,” as it is used throughout this disclosure, shall mean financial contracts pursuant to which an investor makes a loan to the U.S. federal government in exchange for repayment of the principal amount of the loan plus interest. As those skilled in the art will readily appreciate, payment on the debt obligation may be structured in a number of different ways such as, for example, a one-time lump sum payment of the principal plus the interest, or periodic interest payments followed by return of the principal in one lump sum. The term “secured overnight financing rate” or “SOFR,” as it is used throughout this disclosure, shall mean the interest rate that banks pay to borrow money overnight using U.S. treasury debt instruments as collateral. The term “real dollars,” as it is used throughout this disclosure, shall mean the present day value of an amount to be paid in the future after adjusting for expected inflation. The term “guarantee” or “guaranteeing,” as it is used throughout this disclosure, shall mean to achieve a risk level that approximates that of a short-term U.S. government bond. As used herein, “guarantee” or “guaranteeing” should be interpreted as synonymous with “substantially guarantee” or “substantially guaranteeing,” respectively. The term “tradable index,” as it is used throughout this disclosure, shall mean an index that tracks the performance of a single or a group of assets wherein either the index itself or its constituent parts have markets where future expected values can be speculated upon. Tradable indexes include, by way of example only, the Standard & Poor's 500, the Dow Jones Industrial Average, the Nasdaq Composite, the S&P U.S. Aggregate Bond Index, GLD, and WTI. The term “(P_{Min}),” as it is used throughout this disclosure, shall mean the minimum return on investment guaranteed to an investor utilizing the computerized investment strategies described herein. For purposes of this disclosure, (P_{Min}) shall refer to an investor's minimum pre-selected return on investment receivable beginning at time (t) and is interchangeably symbolized as P(t), when no additional higher yielding enhancements are purchased by the investor. The term “F(t),” as it is used throughout this disclosure, shall mean the running operational fees associated with operating an investment fund with regard to a specific (P(t)).

Those of skill in the art will appreciate the availability of alternative labeling of the computerized methods described herein such as computerized investment methods, digitized methods for mitigating risk of currency value fluctuations when preparing for retirement, the invention, or other similar names. Skilled readers should not view the inclusion of any alternative labels as limiting in any way.

Various aspects of the present disclosure will now be described in detail, without limitation. The following disclosure describes computerized methods for administering an investment fund having a plurality of shares, a managed distribution schedule comprising a plurality of consecutive temporal periods and a payment (P(t)) to be provided to an investor during each of the consecutive temporal periods, and an investment strategy for investing in assets to provide funds sufficient to meet the managed distribution schedule. The methods described herein may comprise providing non-transitory memory instructions that cause a computer processor to perform certain method steps as described further below.

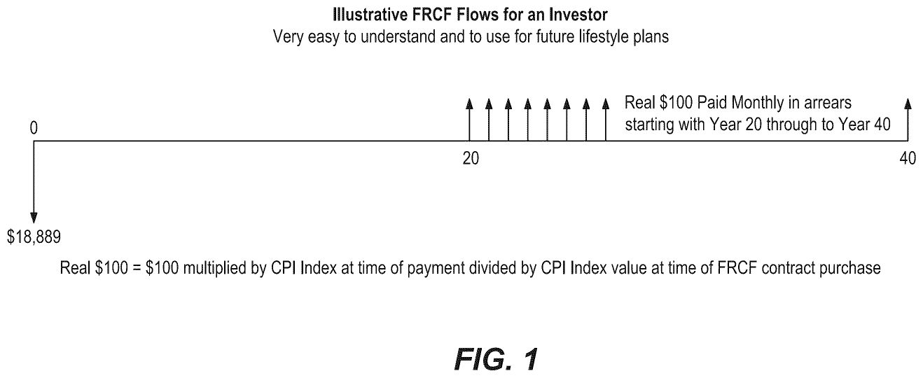

As illustrated in FIG. 1, to maintain at time (t) in the future the purchasing power of $100 dollars today (as an example), one would need to have 100×(Inflation Index value at time (t)/Inflation Index value today (t=0)). This can be expressed as follows, where “CPI” refers to the Consumer Price Index, which constitutes one, non-limiting example of an inflation index as contemplated herein: Future Payout=$100×(CPI (t)/CPI(t=0))=$100×CPI Factor, where CPI(t) is the value of the inflation index at time “t” when payout is expected and CPI(t=0) is the inflation index at time equals zero, when the investment is initially made. As would be readily appreciated by those skilled in the art, future expected CPI(t) values may be extracted from the difference between the nominal U.S. Treasury yields and the corresponding Treasury Inflation Protected Securities (TIPS) yields.

According to the above logic, if the inflation index increases by 10% between t=0 and payout time “t,” the payout would be not $100 but $110, therefore effectively retaining the ability to purchase the same goods at time “t” that $100 purchases today. Thus, the future payout is a real $100 in present day, or “real,” dollars.

As those of skill in the art will readily appreciate, a payout of a real $100 dollars at time “t” has a discounted value today. This can be expressed as follows: Present Value (PV) of Future Payout (PV(P(t))=Future Payout×Discount Factor. Expressing the payout in real dollars facilitates determination of the periodic payments needed in retirement and, therefore, the number of investment units, or shares, needed to support that retirement. The stream of future payments made pursuant to this investment strategy may be referred to as the “Future Real Cash Flow” or “FRCF.”

Following are two examples intended to illustrate the investment principles discussed above.

Example 1: Investor A seeks payments of real $100 (i.e., $100 according to today's standards) at the start of each month, for 20 years, beginning in 10 years. Each monthly future payment has its own inflation adjustment factor and its own discount factor, so as to obtain its (PV(P(t)) today. This is because the inflation adjustment factor and the discount factor fluctuate. The sum total of the (PV(P(t))s for all of the monthly payments is the aggregate present value today of a real $100 (i.e., $100 in today's terms) paid out each month for 20 years starting in 10 years”, and is labeled as PV(P). This cumulative PV(P) may be represented as PV(Real $100, Today, Years of monthly payouts=20, Starting in=10 years) and may be referred to as a single share of FRCF(10×20), meaning the value of a stream of real $100 payments, paid monthly for 20 years starting in 10 years. The investment price of a share of FRCF may include PV(P) plus the present value of the sum total of the running operational fees associated with each P(t) namely the sum total of each PV(F(t)) which is labeled as PV(F). For a simple P(t)=Real $100 payout, the price of a single FRCF share is PV(P)+PV(F) and is labeled as X and assuming zero underwriting fees is the investment unit I.

Example 2: Investor B is 50 years old, plans to retire in 20 years, and seeks a real $5,000 per month in income for twenty years during retirement. Investor B would, therefore, need to purchase 50 units of FRCF($ 100,Today, 20, 20) or in short form FRCF(20×20). The 50 units will deliver the necessary cash flow through to when the person reaches 90 years of age.

A fully developed market of FRCF types as described herein allow for investors to select different payout amounts, for different durations, and beginning at different times (t).

As those of skill in the art will readily appreciate, in addition to inflation, another potential element of risk when investing according to the computerized investment strategies and methods described herein is whether the investment fund will be able to deliver the FRCF at future times (t) and otherwise according to the managed distribution schedule agreed to by an investor and an investment fund.

In an embodiment that mitigates this risk, invested funds X(t), associated with each P(t) may be lent to a repurchase house. The lending of funds X(t) by the investment fund to the repurchase house may be secured by the repurchase house by short-term U.S. treasury debt instruments. In an embodiment, this short-term U.S. treasury debt may have maturities of less than five years. As this investment is secured by short-term U.S. treasury debt instruments, the risk of default by the repurchase house and, therefore, by the investment fund vis-à-vis the investor, closely approximates that of short-term U.S. government debt instruments.

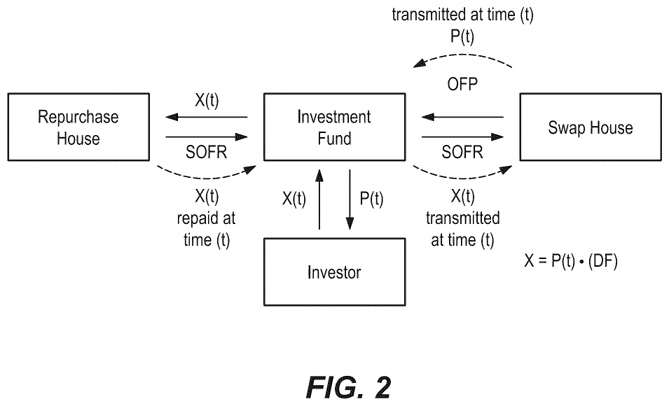

FIG. 2 depicts a specific embodiment of a computerized method intended to mitigate this risk of default. According to this embodiment, an investor transmits investment unit X(t) to an investment fund. The investment fund in turn loans X(t) to a repurchase house in exchange for secured overnight financing rate (“SOFR”) payments. The investment fund in turn transmits these SOFR payments received from the repurchase house to a swap house (e.g., a bank or other financial institution) during the term of the rolling loan in amount X(t) to the repurchase house. While the investment fund is making the SOFR payments to the swap house (i.e., up until time (t)), the swap house may make periodic Operating Fee Payments (OFP) to the investment fund, which may be expressed as a percentage of PV(P(t)). The present value of the OFP is labeled as PV(F(t)). This continues through time (t), at which point X(t) is repaid by the repurchase house to the investment fund. The investment fund then transmits X(t) to the swap house. The swap house then transmits payment P(t) to the investment fund, wherein P(t) represents a real PPU namely $(PPU)=($(PPU)×(CPI(t)/CPI(0)). X(t) is the remainder of the initial investment after underwriting fees are deducted at issuance of the instrument. For purposes of this description, such underwriting fees are assumed to be zero. According to this embodiment, the value of the swap will be secured by short-term U.S. treasury debt instruments.

This same process will repeat at intervals corresponding to the periodic P(t)=real $(PPU) payments selected by the investor when making investment X at time t=0 (e.g., monthly for 20 years). According to this embodiment, the value of the swap cash flows for each P(t)=real $(PPU) payment will be secured by short-term U.S. treasury debt instruments. This means that the sum total of all swap cash flows will be secured by short-term U.S. treasury debt instruments.

Earning SOFR in the repurchase market and paying SOFR on the swap ensures or substantially ensures no slippage between the two for the investment fund and helps the swap house with its hedges because the swap house does not need to take any positions on a long-dated basis swap. According to this embodiment, there will be no basis risk between earnings and what is owed on the swap. This removes any possibility of long-term basis risks in the structure and makes for efficient hedging by the swap house.

Both the funds lent to the repurchase house and the present value of the SOFR payments from the repurchase house to the investment fund are collateralized by short term U.S. treasury debt instruments. Likewise the net value of the SOFR payments to the swap house and the OFP and P(t) payments from the swap house, for all P(t) payments, are collateralized by short term U.S. debt securities. Hence the total risk to the investor approximates that of short-term U.S. treasury debt instruments. Accordingly, an investor is guaranteed to receive the FRCF that he or she was promised.

In an embodiment, the investment fund's fee(s) and potentially any fee(s) charged by brokerage houses will not come from the selling of FRCF shares. The periodic operating fee payments (OFP) made by the swap house to the investment fund are designed to cover such recurring fees. Underwriting fees charged by the investment fund to the investor are covered by the issuance price (I) of the FRCF units charged to the investor at time t=0. Fund documentation accessible through the computer programs described herein will disclose these fees to actual and prospective investors. Issuance price I=X+(Underwriting Fees)

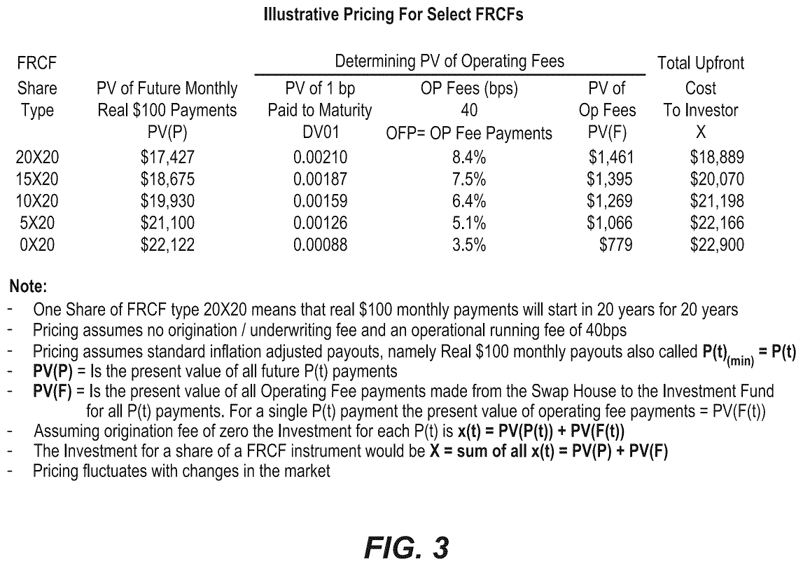

FIG. 3 demonstrates example pricing of the FRCF shares described herein where P(t)=Real $100. Issuance price (I) for the shares may be determined by multiplying DV01 by 40 basis points (a sample running operating fee) to arrive at a percentage fee. Aggregate PV(P) may then be multiplied by this percentage fee to determine present value of the OFP namely PV(F). This PV(F) may then be added to PV(P) to obtain “X” the value of a FRCF share. The issuance price may include an underwriting fee, so the price paid by the investor would be I=X+underwriting fee. In FIG. 3 the underwriting fee is assumed to be zero.

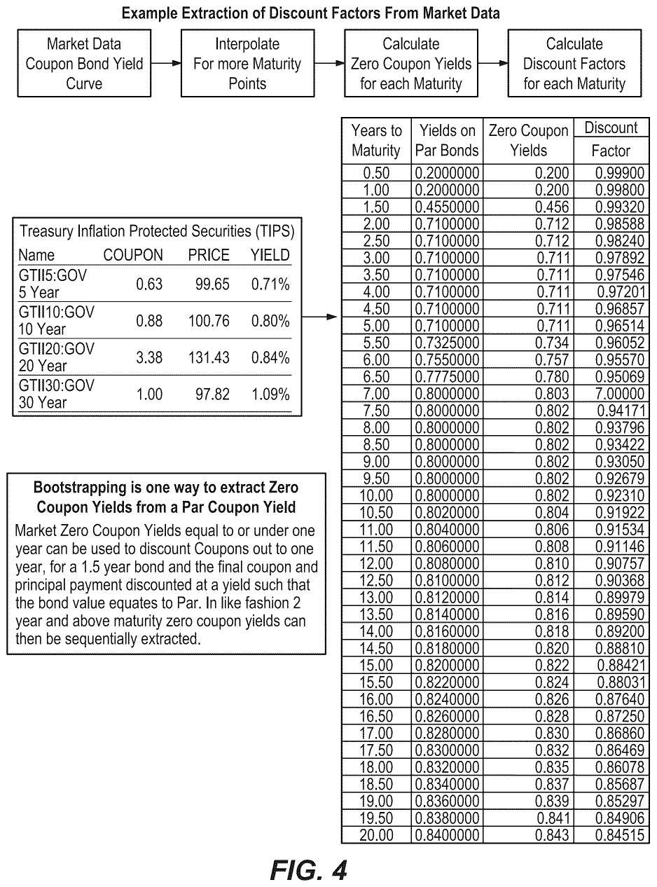

As would be readily appreciated by those skilled in the art, the PV(P) may be determined by discounting future real payments to today using discount factors derived from a real discount curve. The real discount curve may be extracted from the Treasury Inflation Protected Securities (TIPS) market. From the real discount curve, discount factors may be extrapolated to a future payment date(s). FIG. 4 illustrates how the discount factors may be determined based upon market data.

Higher-yield investments may be incorporated into the computerized investment methods described herein. These modified investments may be expressed as follows (using PPU=$100 as an example): Future Payout P(t)=(100*(CPI(t)/CPI(t=0)))+(100*Max{Return on selected Exposure, Zero}). Adoption of the above approach is intended to enhance the probability that the investor receives no less than the pre-determined real dollars payout (e.g., $100) that he or she planned on receiving at the time of the initial investment (t=0).

“Return on Selected Exposure,” is used herein as an umbrella term that may refer to an investor's return on any number of specific investment instruments struck at any number of possible strike prices. Such investment instruments may include, without limitation, financial derivatives.

In an embodiment, “Return on Selected Exposure” may refer to protection against deflation and may be expressed as follows: Return on Selected Exposure=Max{(1−CPI(t)/CPI(t=0)), 0} i.e. with deflation protection P(t)=PPU.

In an alternative embodiment, “Return on Selected Exposure” may refer to outperformance of the S&P 500 over inflation. This embodiment may be expressed as follows:

Return on Selected Exposure =Max{x(S&P500 TR−CPI TR), Zero}, where “TR” refers to Total Return.

In general, the addition of higher yielding assets will be included as described above which are in derivative terms being long Call and/or Put Options. Such long Options can only be additive but do come at an upfront cost.

In an embodiment, the Investor pays I where:

I=Underwriting Fees+PV(P)+PV(F)+PV(Options)

Or more concisely:

I=Underwriting Fees+X+PV(options)

Or more concisely:

I=Underwriting Fee+X′ (for simplicity X is used to symbolize both X or X′)

In an embodiment, investment unit shares as described herein, which may be referred to as future real cash flow (FRCF) shares may be offered and sold in the marketplace as an exchange traded fund (ETF) through brokerage platforms. As with any ETF, in an embodiment, creation units and unwinding of shares may be permitted, as necessary based on consumer demand.

In an embodiment, FRCF shares issued in connection with the computerized methods described herein may be apportioned in a manner such that the price (I) to the investor fosters a high degree of liquidity in the market for the FRCF shares. This approach may facilitate continued investment in the FRCF units and enhance liquidity in a secondary market for the FRCF units.

Investment strategies such as those described herein may serve as a conceptual basis for a computerized method for administering an investment fund having a plurality of shares, a managed distribution schedule comprising a plurality of consecutive temporal periods (e.g., months, weeks, years, etc.) and a payment (P(t)) to be provided to an investor during each of the consecutive temporal periods. The investment strategies described herein are intended to invest in assets to provide funds sufficient to meet the managed distribution schedule.

Computerized methods as described herein may comprise providing a computer processor specially programmed with instructions for performing method steps. The method steps may comprise modeling, with the computer processor, an investment strategy, such as described above, by defining a future real cash flow (FRCF) equal to payout P(t)=PPU (payout desired in dollar terms as of the date of the investment i.e., t=0), multiplied by inflation factor (IF). The computer processor may calculate IF by dividing a projected future inflation index at time (t) by inflation index at time of investment (t=0). Any credible and validated inflation index may be used for purposes of this investment strategy. One non-limiting example being the CPI.

The method steps may further comprise a computer processor generating a visual output comprising digital images comprising a series of potential start dates for the payments (P(t)) to begin, and a series of potential number of consecutive temporal periods for which the payments (P(t)) will continue to be made, at the time of the initial investment or potential investment.

The method steps may further comprise the computer processor calculating, based on the input, the actual value (P(t)), as well as the aggregate value expressed in real dollars at t=0 (PV(P(t)), of each of the payments (P(t)) to be provided according to the managed distribution schedule using the computerized investment strategy; the computer processor calculating a price (I) per investment unit FRCF, which price calculation may be performed according to the methods discussed herein; and the computer processor receiving as an input via a user interface an instruction from the investor whether or not to execute a purchase at price (I).

The computer processor utilized in connection with the computerized methods described herein may be programmed with instructions to lend funds received through the investment (X) to a repurchase house, upon receipt of digital confirmation from the repurchase house that the repurchase house has agreed to a set of pre-determined terms (T_{Repo}) governing repayment of the funds; wherein (T_{Repo}) includes a term stating that the investment fund receives interest from the repurchase house in an amount substantially equal to a secured overnight financing rate (SOFR) in exchange for lending (X) to the repurchase house.

The computer processors described herein may be programmed with instructions to transmit the SOFR received by the investment fund from the repurchase house to a swap house upon receipt of digital confirmation that the swap house has agreed to a set of pre-determined terms (T_{Swap}), inclusive of the swap house's obligations, governing repayment of the funds.

In an embodiment of a computerized method as described herein (T_{Repo}) may include terms requiring that (i) the repurchase house will pay the investment fund a pre-determined amount of interest (SOFR) during the term of the loan; and (ii) the loan to the repurchase house as well as the SOFR must be collateralized by short-term U.S. treasury debt instruments.

In an embodiment, (T_{Swap}) may include terms requiring payment to the investment fund, by the swap house, fixed (OFP) amounts upon transmission of SOFR amounts from the investment fund to the swap house during the term of the swap.

In an embodiment, (T_{Swap}) may include terms requiring payment to the investment fund of periodic P(t) payments starting and ending at pre-determined dates upon transmission of corresponding X(t) amounts from the investment fund to the swap house.

In an embodiment, (T_{Swap}) may include a term requiring that the net obligations of the swap house must be collateralized by short-term U.S. treasury debt instruments. The short-term treasury debt instruments may have a maturity equal to five years of less.

In an embodiment, the method steps described herein may further comprise the computer processor generating a visual output comprising digital images corresponding to a plurality of auxiliary investment options. The plurality of auxiliary investment options may include investment instruments intended to hedge against risk of payments (P(t)) decreasing due to deflation. The plurality of auxiliary investment options may include investment instruments intended to track performance of a tradable index while still guaranteeing (P_{Min}).

In an embodiment, (T_{Swap}) may include a term that the swap house will invest a pre-determined amount of funds from (X) and associated SOFR payments in one or more of the plurality of auxiliary investment options.

While various aspects of methods enabled by this disclosure have been described above, the description of this disclosure is intended to illustrate and not limit the scope of the claims. The claims are not intended to be limited by the illustrations and examples provided in the above disclosure. Skilled artisans will appreciate additional aspects of the methods enabled by this disclosure, which may be realized in alternative embodiments, after having read the above disclosure. Other aspects, advantages, embodiments, and modifications are within the scope of the claims.

What is claimed is:

1. A method for administering an investment fund having a plurality of shares, a managed distribution schedule comprising a plurality of consecutive temporal periods and a payment (P(t)) to be provided to an investor during each of the consecutive temporal periods, and an investment strategy for investing in assets to provide funds sufficient to meet the managed distribution schedule, the method comprising:
providing non-transitory memory instructions that cause a computer processor to perform method steps comprising:
modeling, with the computer processor, the investment strategy by defining future real cash flows (FRCF) each equal to (P(t)), wherein (P(t)) equals a predetermined payout unit PPU multiplied by inflation factor (IF), wherein the computer processor calculates (IF) by dividing a projected future inflation index at time (t) by inflation index at time of investment (t=0), such that the present value of (P(t)), plus the present value of (F(t)), is investment unit (X(t));
the computer processor generating a visual output comprising digital images comprising a series of potential start dates for the payments (P(t)) to begin, and a series of potential number of consecutive temporal periods for which the payments (P(t)) will continue to be made;
the computer processor receiving as an input via a user interface selected values for a start date for the payments (P(t)) to begin, and a number of consecutive temporal periods for which the payments (P(t)) will continue to be made;
the computer processor calculating, based on the input, the value of each of the payments (P(t)) to be provided according to the managed distribution schedule using the investment strategy;
the computer processor calculating a price (I) per investment unit (FRCF); and
the computer processor receiving as an input via a user interface an instruction from the investor whether or not to execute a purchase at price (I).

2. The method of claim 1, wherein:
the computer processor is programmed with instructions to loan funds received through purchase of the investment unit (FRCF), (X), to a repurchase house, upon receipt of digital confirmation from the repurchase house that the repurchase house has agreed to a set of pre-determined terms (T_{Repo}) governing repayment of the funds to the investment fund; and
the investment fund receives interest from the repurchase house in an amount substantially equal to a secured overnight financing rate (SOFR).

3. The method of claim 2, wherein:
(T_{Repo}) includes terms requiring that (i) the repurchase house will pay the investment fund a pre-determined amount of interest (SOFR); and (ii) the loan made by the investment fund to the repurchase house plus the SOFR payments due must be collateralized by short-term U.S. treasury debt instruments; and (iii) (X(t)) associated with each (P(t)) will be paid to the investment fund and thereafter paid to the swap house.

4. The method of claim 3, wherein:
the computer processor is programmed with instructions to transmit the SOFR received by the investment fund from the repurchase house to a swap house upon receipt of digital confirmation that the swap house has agreed to net obligations memorialized in a set of pre-determined terms (T_{Swap}) governing repayment of the funds; and
wherein the swap house receives from the investment fund X(t) for each P(t) payment the swap house makes to the investment fund.

5. The method of claim 4, wherein (T_{swap}) includes terms requiring a series of future periodic payments (P(t)) from the swap house to the investment fund.

6. The method of claim 5, wherein (T_{Swap}) includes terms requiring payment to the investment fund of running (F(t)) upon transmission of (SOFR) from the investment fund to the swap house.

7. The method of claim 6, wherein (T_{Swap}) includes a term requiring that the present value of the net obligations of the swap house must be collateralized by short-term U.S. treasury debt instruments.

8. The method of claim 7, wherein the short-term U.S. treasury debt instruments have a maturity equal to five years or less.

9. The method of claim 8, wherein the method steps further comprise the computer processor generating a visual output comprising digital images corresponding to a plurality of auxiliary investment options.

10. The method of claim 9, wherein the plurality of auxiliary investment options includes investment instruments that deliver payments expressed as P(t)=PPU*CPI(t)/CPI(0)+PPU *Max(Return on Selected exposure, 0).

11. The method of claim 10, wherein the plurality of auxiliary investment options includes investment instruments intended to track performance of a tradable index while still guaranteeing the investor (P_{Min}).
